(19) United States
(12) Patent Application Publication
(10) Pub. No.: US 2025/0310862 A1
(43) Pub. Date: Oct. 2, 2025

(54) NETWORK FUNCTION DETERMINATION BASED ON SHARED COMPUTING ENTITY

(71) Applicant: T-Mobile USA, Inc., Bellevue, WA (US)

(72) Inventors: Prannoy Kiran Saride, Bellevue, WA (US); Akbar Aman, Overland Park, KS (US)

(21) Appl. No.: 19/081,612

(22) Filed: Mar. 17, 2025

Related U.S. Application Data
(60) Provisional application No. 63/570,617, filed on Mar. 27, 2024.

(51) Int. Cl. H04W 48/14; H04W 60/06; H04W 76/10

(52) U.S. Cl. CPC H04W 48/14; H04W 60/06; H04W 76/10

(57) ABSTRACT

Techniques for determining a network function (NF) producer for use by a user equipment (UE) in a telecommunications network are described herein. The telecommunications network can implement a computing device to determine that a first NF producer is not available to provide a user plane and/or a control plane to the UE, and further determine a second NF producer for exchanging data with the UE. The computing device can automatically employ the second NF producer to establish a communication channel for the UE without explicitly notifying the UE that the first NF producer is unavailable.

### RELATED APPLICATIONS

This application claims priority to U.S. Provisional Application No. 63/570,617, filed on Mar. 27, 2024, the entirety of which is incorporated herein by reference.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example user equipment can connect to a telecommunications system that includes an example access management system to implement the techniques described herein.

FIG. 2 depicts an example system architecture for a fifth generation (5G) telecommunication network.

FIG. 3 depicts an example network environment in which an example access management system can determine a network function producer to provide a communication session for an example user equipment.

FIG. 4 depicts a messaging flow for providing a response to a request for a network function using an example access management system.

FIG. 5 depicts a flowchart of an example process for providing a communication session using an example network function producer.

FIG. 6 depicts an example system architecture for a user equipment.

### DETAILED DESCRIPTION

This application relates to techniques for determining a network function (NF) producer for use by a user equipment (UE) in a telecommunications network. The techniques can include a telecommunications system implementing a computing device to determine that a first NF producer is not available to provide a user plane and/or a control plane to the UE, and further determine a second NF producer for exchanging data with the UE. By way of example and not limitation, the UE may send a message that identifies the first NF producer (e.g., in a header of the message) for accessing the Internet or placing a call to another device. By using the techniques described herein, the computing device can automatically employ the second NF producer to establish a communication channel for the UE regardless of the reason that the first NF producer is unavailable and independent of notifying the UE that the first NF producer is unavailable.

An NF producer can represent an entity providing network function capabilities to an NF consumer such as the UE. In various examples, the NF producer can represent one of a variety of network function types associated with the telecommunications network. Examples of some network functions associated with a 5G telecommunications system are included below.

In some examples, the techniques can include the computing device analyzing data received from the UE at a time and/or over a time period, and outputting an indication of a candidate NF producer(s) available for associating with a message from the UE. For example, the computing device can parse a message to detect a header such as a 3gpp-sbi-target-api-root header that includes an application program interface (API) root of the target (e.g., a target universal resource identifier (URI), a target NF producer, etc.). In some examples, the message can be sent over a 5G network using a Service Communication Proxy (SCP). By way of example and not limitation, the UE can send a message using the SCP to perform “indirect communication”, and the computing device can determine the NF producer independent of the “target” NF producer included in the message. In this way, an NF producer can be available to the UE to enable an exchange of data in examples when the target NF producer is deregistered or otherwise unavailable using the 5G network.

In various examples, a UE can determine a first communication session using a first NF producer (e.g., to connect to an HTTP server) and later disconnect from the first NF producer. For example, the UE can remain idle for a period of time or otherwise disconnect (or deregister) from the first NF producer at a first time. At a second time the UE can send a request to establish a second communication session with the first NF producer. At the second time, the first NF producer may no longer be available (e.g., offline for an update, running at capacity, etc.), and the techniques can include the computing device detecting that the first NF producer is unavailable (e.g., associated with an offline status), and identifying a second NF producer for use with the second communication session. In various examples, the second NF producer can be provided to the UE instead of the UE receiving an error associated with the first NF producer being unavailable and/or independent of the UE sending a message targeting a particular NF producer. For example, the computing device can determine that the first NF producer and the second NF producer share a same computing entity (e.g., database, server, processor, memory, or the like) and assign the second NF producer to the UE based on the first and second NF producers sharing the same computing entity. By way of example and not limitation, the computing device can establish the second communication session using the second NF producer regardless of whether the UE sent a 3gpp-sbi-target-api-root header identifying the first NF producer.

The techniques described herein can be used to control which NF producers are accessed by a UE regardless of whether the UE specifies or requests a particular NF producer in a message. In some examples, a UE and/or an NF producer can deregister or disconnect from a network, and the techniques can include determining an available NF producer for the UE regardless of the NF producer targeted or previously used by the UE.

In various examples, the techniques can be implemented by a service communication proxy (SCP) to enable “indirect communication” between the UE and one or more NF producers. For example, the SCP can proactively determine a relationship (e.g., a similarity score) among two NF producers (e.g., share a same computing entity) and configure a communication session for the UE using a non-request NF producer based on the relationship. In various examples, the SCP can identify that a requested NF producer is not connected to a network or otherwise unable to configure additional communication sessions, and select a new NF producer that shares a database with the requested NF producer. By identifying an alternate NF producer, the SCP can proactively manage selection of an NF producer instead of the SCP sending a message to the UE indicating that the requested NF producer in unable to establish the communication session.

In some examples, the SCP can exchange data with a network repository function (NRF) and determine an NF producer for a particular communication session based on the exchanged data. For example, the SCP can receive a status of various NF producers (also referred to as NF services) indicating whether or not an NF producer is available to provide a communication session. In some examples, registration and/or deregistration information of various NF producers can be updated over time by the NRF, and the SCP can access the registration status along with an indication of whether the NF producer shares a database with at least one other NF producer (e.g., a database synchronized to a first NF producer and a second NF producer).

In various example, the techniques enable fewer messages to be transmitted over a network (e.g., the core network) by determining NF producer to provide a communication session with a UE. By exchanging fewer messages to establish a communication session, additional bandwidth is available on the core network (e.g., for authorized or unauthorized emergency calls). Further, using the techniques described herein can improve transmission of message data between an NF producer and a UE using a telecommunications network by reducing latency associated with identifying an available NF producer over time.

Though some examples are described in relation to a UE, in various examples one or more computing devices, networks, or other entities may perform or otherwise be associated with the techniques described herein.

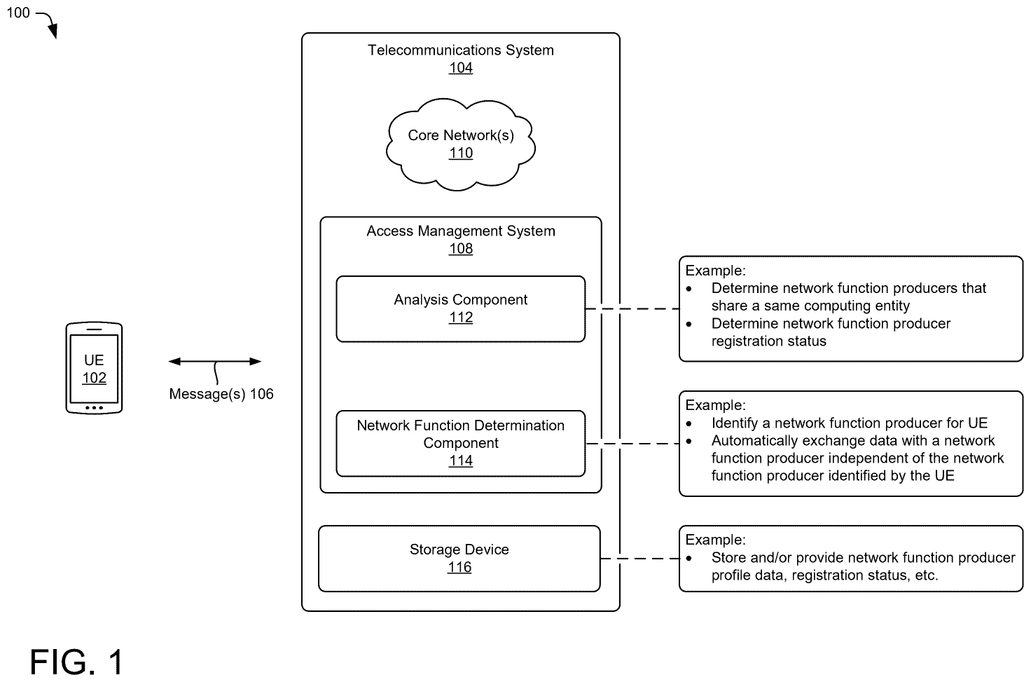

FIG. 1 depicts an example network environment 100 in which an example user equipment can connect to a telecommunications system that includes an example access management system to implement the techniques described herein. For example, a UE 102 can request access to a telecommunications system 104 by sending a message(s) 106 to the telecommunications system 104 for a communication channel. In various examples, an access management system 108 can determine an NF producer to provide the communication channel for the UE 102. In various examples, the UE 102 can receive the communication channel from the access management system 108 independent of whether the UE 102 requests a particular NF producer (e.g., in a header or other portion of the message 106).

The UE 102 may represent any device that can wirelessly connect to the telecommunication network, and in some examples may include a mobile phone such as a smart phone or other cellular phone, a personal digital assistant (PDA), a personal computer (PC) such as a laptop, desktop, or workstation, a media player, a tablet, a gaming device, a smart watch, a hotspot, a Machine to Machine device (M2M), a vehicle (e.g., an autonomous vehicle, an unmanned aerial vehicle, airplane, boat, etc.), an Internet of Things (IoT) device, a sensor, or any other type of computing or communication device.

The telecommunications system 104 can represent a 5G system, for example.

The access management system 108 may represent firmware, hardware and/or software that generates, assigns, selects, or otherwise determines an NF producer(s) for the UE 102 to connect to the core network(s) 110. In various examples, the access management system 108 can determine a network function for providing a communication session for the UE 102. The access management system 108 may, for example, determine that a first NF producer is not available to provide a user plane and/or a control plane to the UE 102, and identify a second NF producer for exchanging data with the UE 102. In some examples, the core network(s) 110 can exchange data with the UE 102 using the second NF producer independent of whether the UE 102 requested to use the first NF producer and/or without notifying the UE 102 that the second NF producer is being used. In some examples, the access management system 108 can represent an SCP, or another proxy type, operating in the telecommunications system 104.

In various examples, the access management system 108 can receive the message 106 (e.g., a first message at a first time) from the UE 102 requesting an NF producer for a communication session. For example, the message 106 can include data identifying a particular type of network function to use for the communication session. In some examples, the message 106 can represent a message (e.g., a second message at a second time after the first time) from the access management system 108 to the UE 102 to establish the communication session using a network function determined by the access management system 108. For example, the message 106 can represent an exchange of data between the UE 102 and the access management system 108 using a different network function producer than the one specified in a previous message from the UE 102.

In various examples, the UE 102 can send the message 106 requesting a communication session with another device, the Internet, a service, etc. and the access management system 108 can transmit NF producer information to the UE 102 independent of whether the UE 102 specified a particular NF producer for the communication session.

The core network 110 can, for example, represent a 5G network though other core network types may also be used (e.g., past or future generation networks such as a sixth generation (6G) network).

FIG. 1 further depicts the access management system 108 comprising an analysis component 112 and a network function determination component 114. FIG. 1 further depicts the telecommunications system 104 (e.g., a 5G system) comprising the access management system 108, the core network(s) 110, and a storage device 116. The access management system 108 (or component thereof) may, for example, exchange data with the storage device 116 (e.g., a memory, a database, etc.) to implement the access techniques described herein.

The analysis component 112 can, for example, represent functionality to determine whether two or more NF producers share a same computing entity (e.g., database, server, processor, memory, or the like) or are otherwise related. For example, the analysis component 112 can access a pre-determined list of NF functions sharing at least one computing entity to determine which NF producers share a same storage device, database, processor during execution, etc. For example, a current list of NF producers available to provide a communication session can be included in the storage device 116 and be updated based on current NF producer data received from a respective NF producer. In some examples, the analysis component 112 can receive NF producer profiles and compare respective profile information to determine which NF producers share a same database, server, or the like.

In various examples, the analysis component 112 can determine a registration status of one or more NF producers based on data exchanged with an a network repository function (NRF). The registration status can indicate whether a respective NF producer is connected (e.g., registered) or not connected (e.g., deregistered) from the core network 110. In some examples, registration and/or deregistration information of various NF producers can be updated over time by the NRF, and the analysis component 112 can access the registration status along with an indication of whether the NF producer shares a computing entity with at least one other NF producer. In various examples, registration status information can be stored in the storage device 116 which can represent a cache, database, or other type of memory or storage device that is synchronized to a first NF producer and a second NF producer. For example, the first NF producer and the second NF producer can send updated NF producer data automatically to the NRF responsive to changes in the NF producer data (e.g., a change in registration status or change in other profile data, as described herein.).

In some examples, the analysis component 112 can determine a score to represent a level of similarity between two NF producers, and determine an NF producer for the UE 102 based on the respective scores. For example, the analysis component 112 can compare profile data of respective NF producers and assign a score, value, or the like to indicate similarity between information in the respective profiles. For example, two NF producers may have a higher similarity score. In various examples, the NF producers having the highest score can be considered “related” and the NF producer of the NF producers that is registered to a core network can be assigned to the UE 102.

The network function determination component 114 can represent functionality to identify, select, or otherwise determine NF producers (e.g., candidate NF producers) available for providing a communication session and/or communication channel to the UE 102. In some examples, the network function determination component 114 can automatically exchange data with an NF producer that is different from an NF producer specified by the UE 102 (e.g., in the message 106) without the UE 102 being required to receive a message to indicate that a different NF producer is being used (than the one specified). The network function determination component 114 can determine the NF producer based on analyzing one or more of: the registration status, an indication of a shared computing entity, a network function type, or an output by the analysis component 112, just to name a few. The network function determination component 114 can determine the NF producer using any of the techniques described herein. In various examples, the network function determination component 114 can output an indication of a candidate NF producer(s) available for using to exchange data as a message 106 with the UE 102.

The storage device 116 can represent, for example, a Unified Data Management (UDM) to manage user data and/or an Authentication Server Function (AUSF) to manage authorization for the UE 102 (e.g., in the 5G system shown). However, in examples when the core network is a different type, such as 4G, the storage device 116 can represent a Home Subscriber Server (HSS). Thus, the storage device 116 can represent various subscription management entities depending upon the example core network used to employ the techniques. In some examples, the storage device 116 can represent a cache that is associated with or operated in association with the access management system 108.

In some examples, the storage device 116 can store and/or provide data for use by a component or model. For example, the storage device 116 can represent a memory, cache, or other type of storage device that may store NF producer profile data, UE data (e.g., authorization status, UE behavior, etc.), or the like. In some examples, the NF producer profile data can include any data provided by a particular NF producer representing characteristics such as an identifier, an IP address, an NF producer type, and/or a domain name (e.g., a fully qualified domain name (FQDN)), among others. In various examples, the storage device 116 can receive profile data from NF producers at predetermined intervals and/or dynamically as changes the NF producer modifies the profile data. For example, as NF producers register and deregister (or status thereof) from the core network(s) 110, updated profile data can be sent to the storage device 116 that is synchronized to receive updates from the NF producers.

In various examples, output data from a component of the access management system 108 can be stored in the storage device 116 for access or retrieval at a later time. For example, the storage device 116 can receive data associated with a core network, an NF producer, the UE, or the like, for storage and make such data available to a component for processing at a later time (e.g., to determine an NF producer).

To implement the techniques described herein, in various examples the telecommunications system 104 and/or the access management system 108 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 104 (e.g., a 5G system) can represent functionality to provide a communication channel for the UE 102, and can include one or more radio access networks (RANs), as well as one or more core networks linked to the RANs. For instance, the UE 102 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 104 is compatible to operate with other radio technologies including those of other service providers. Accordingly, the message(s) 106 from the UE 102 may originate with another service provider (e.g., a third-party) and be processed by the access management system 108 independent of the technolog(ies) or core network associated with the service provider.

While shown separately in FIG. 1, the analysis component 112 and the network function determination component 114 (and the functionality thereof) can be included in a single component of the access management system 108 and/or in another computing device (e.g., the UE 102 or another device associated with the telecommunications system 104). Further, the functionality associated with the access management system 108 can be included as hardware, firmware, or the like coupled to the UE 102.

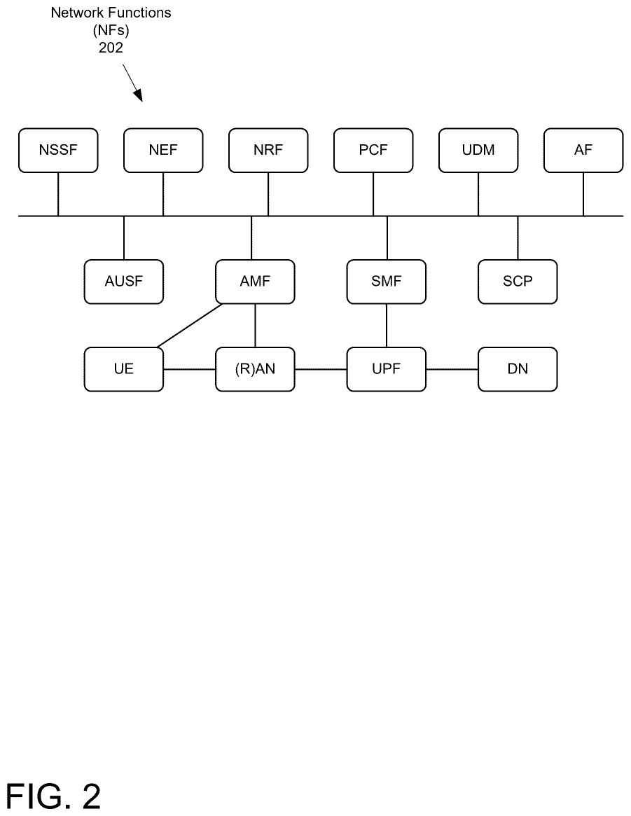

In some examples, the core network 110 can represent a service-based architecture that includes multiple types of network functions that process control plane data and/or user plane data to implement services for the UE 102. In some examples, the services comprise rich communication services (RCS), a VoNR service, a ViNR service, and the like which may include a text, a data file transfer, an image, a video, or a combination thereof. The network functions of the core network 110 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 110 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 110 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 110 can, in some examples, determine a connection between an IP Multimedia Subsystem (IMS) that manages a communication session for the UE 102, including sessions for short messaging, voice calls, video calls, and/or other types of communications. For example, the UE 102 and the IMS of the telecommunications system 104 can exchange Session Initiation Protocol (SIP) messages to set up and manage individual communication sessions. In some examples, the IMS of the telecommunications system 104 can generate a network slice to act as a communication channel for a voice communication, video communication, or other communication between the UE 102 and another computing device.

Though some examples in FIG. 1 and elsewhere are described in association with a 5G telecommunication system, the techniques described herein can be used in other telecommunication system types include past generation and/or future generation telecommunication systems.

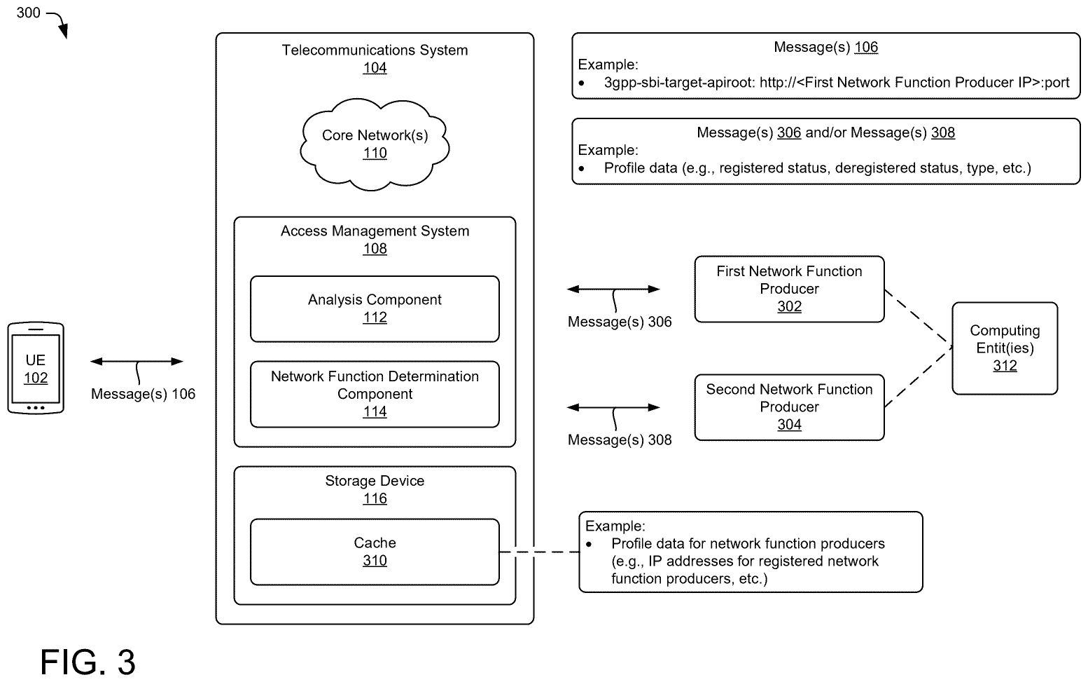

FIG. 3 depicts an example network environment 300 in which an example access management system can determine an NF producer to provide a communication session for an example user equipment. For example, the access management system 108 of FIG. 1 can determine to use a first NF producer 302 or a second NF producer 304 to provide a communication session for the UE 102.

The access management system 108 can exchange one or more messages 306 with the first NF producer 302 and/or one or more messages 308 with the second NF producer 304 (e.g., via the core network(s) 110). The message(s) 306 and/or the message(s) 308 can include profile data for a respective NF producer which can include, for example, a registration status (e.g., a registered status or a deregistered status), a type of NF producer, an identifier for the NF producer, an IP address port information, or the like. In various examples, the message(s) 306 and/or the message(s) 308 can be received over time to indicate changes in profile data for various NF producers. Data associated with the message(s) 306 and/or the message(s) 308 (e.g., profile data, etc.) can be stored in the storage device 116.

FIG. 3 depicts the storage device 116 including a cache 310. The cache 310 can be updated over time to store current profile data for various NF producers, for example. In some examples, first data stored in the cache 310 representing profile data for the first NF producer 302 can be replaced with second data representing updated profile data for the first NF producer 302. In some examples, the cache 310 can be updated in response to a change in registration status. In some examples, the cache 310 can receive data from a network repository function (NRF). In some examples, the cache 310 stores data for registered NF producers, and deregistered NF producers are not included in the cache 310. However, in other examples, the cache 310 can include data for registered NF producers and deregistered NF producers.

By way of example and not limitation, the UE 102 can send the message 106 to the core network(s) 110 requesting a communication session with the first NF producer 302. For example, the message 106 can include a header such as: 3gpp-sbi-target-apiroot: http://<First Network Function Producer IP>: port that indicates to use the first NF producer 302 (or IP address thereof). The analysis component 112 can access or retrieve data from the cache 310 for the first NF producer 302 using an identifier, an IP address, or other data associated with the first NF producer 302. In some examples, the analysis component 112 can analyze the accessed data to determine that the first NF producer 302 is not available to provide the communication session to the UE 102. In various examples, the analysis component 112 can determine that the first NF producer 302 is not available based on data not being available in the cache 310 for the first NF producer 302.

Based on the first NF producer 302 not being available for the communication session (e.g., deregistered), the analysis component 112 can determine a relationship or feature in common between the first NF producer 302 and the second NF producer 304. For example, the analysis component 112 can compare first profile data of the first NF producer 302 with second profile data of the second NF producer 304 and determine whether the profile data indicates a computing entit (ies) 312 that is included in both the first profile data and the second profile data. For example, the first profile data and/or the second profile data can indicate that the first NF producer 302 and the second NF producer 304 share a database. Based on the sharing of the computing entit (ies) 312, the analysis component 112 can output an indication to use the second NF producer 304 instead of the first NF producer 302. In various examples, the access management system 108 can determine to use the second NF producer 304 for the communication session independent of the UE 102 requesting the first NF producer 302.

In some examples, the analysis component 112 can analyze messages received from the UE over a time period, and output indications of which NF producer(s) are included in respective messages. For example, the computing device can parse a message to detect a header that includes an application program interface (API) root of the target (e.g., a target universal resource identifier (URI), a target NF producer, etc.).

In various examples, the second NF producer 304 can be provided to the UE 102 instead of the UE 102 receiving an error associated with the first NF producer 302 being unavailable and/or independent of the UE 102 sending a message 106 identifying or targeting a particular NF producer. For example, the computing device can determine that the first NF producer 302 and the second NF producer 304 share a same computing entity (e.g., database, server, processor, memory, or the like) and assign the second NF producer 304 to the UE 102 based on the first and second NF producers sharing the same computing entity.

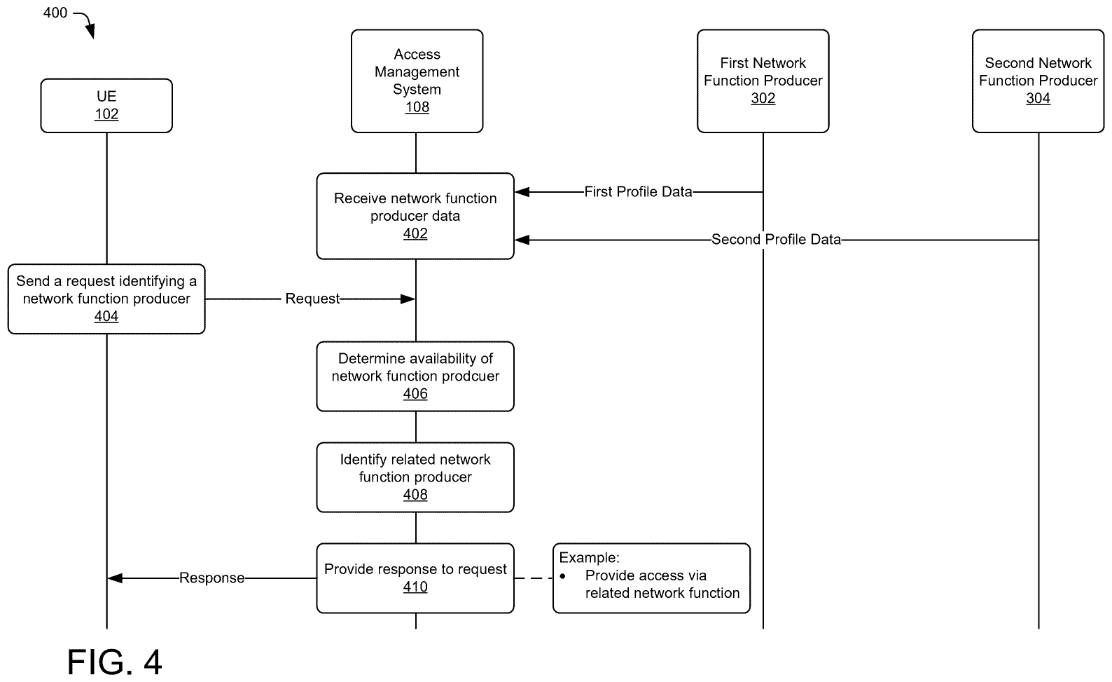

FIG. 4 depicts a messaging flow 400 for providing a response to a request for a network function using an example access management system. For example, the UE 102 of FIG. 1 may exchange (e.g., send and/or receive) one or more messages with the access management system 108 (e.g., the analysis component 112 and/or the network function determination component 114) to determine an NF producer for providing service to the UE 102. In some examples, the access management system 108 can determine a network function producer for providing service to the UE 102 that is different from another NF producer requested by the UE 102, as describe herein. In various examples, the access management system 108 can be part of or otherwise represent a computing device operated by the telecommunications system 104.

At 402, the access management system 108 can receive NF producer data. For example, the access management system 108 can receive first profile data from the first NF producer 302 and/or second profile data from the second NF producer 304. The profile data can include an IP address, a registration status, an identifier (e.g., a domain name, etc.), a computing entity used for processing, memory, and/or data storage. In some examples, the first profile data and/or the second profile data can indicate a database for storing computer-readable instructions associated with various NF producers. The profile data may also indicate a network exposure function usable for executing calls to functions outside the core network.

In some examples, the access management system 108 can receive NF producer data for storing in a storage device such as a cache (e.g., the cache 310). Over time the access management system 108 can receive new or updated NF producer data and update an instance of the respective NF producer in the cache 310.

At 404, the UE 102 can send a request associated with an application, service, etc. over the core network(s) 110 to the access management system 108 of the telecommunications system 104. For example, the UE 102 can send a message requesting access to a particular service or application (e.g., to access to the Internet, place a call, etc.) and indicate an NF producer in a header or other portion of the message. In examples, the access management system 108 can detect the NF producer indicated in the message from the UE 102. In some examples, the request can indicate a network exposure function for calling a function outside the core network 110.

At 406, the access management system 108 can determine availability of the network function producer. For example, the analysis component 112 can identify whether the network function indicated in the message is registered or deregistered with a core network. In some examples, the analysis component 112 can parse the first profile data to determine whether the first NF producer 302 is associated with a registrant status and/or a deregistered status. In some examples, the analysis component 112 can determine that first NF producer 302 is associated with a deregistered status and therefore unavailable to provide access to the UE 102. In various examples, the analysis component 112 can determine whether a network exposure function is available for the UE 102.

At 408, the access management system 108 can identify another NF producer that is related to the unavailable NF producer. In some examples, the analysis component 112 can compare the first profile data and the second profile data to find a relationship between the first NF producer 302 and the second NF producer 304. In various examples, the analysis component 112 can determine that the first NF producer 302 and the second NF producer 304 share a same computing entity (e.g., a database).

In various examples, the analysis component 112 can identify another network exposure function that is available for the UE 102. For example, the analysis component 112 can compare respective network exposure function information associated with profile data and determine whether another network exposure function is available (independent of whether the network exposure functions share a same computing entity or not).

At 410, the access management system 108 can provide a response to the request from the UE 102. For instance, the access management system 108 can provide a communication session that enables the service, application, etc. requested by the UE 102. In various examples, the communication session can be provided to the UE 102 using the second NF producer 304 and without otherwise notifying the UE 102 that the first NF producer 302 is deregistered. The access management system 108 can, for example, provide the UE 102 access to the core network(s) 110 using the related NF producer.

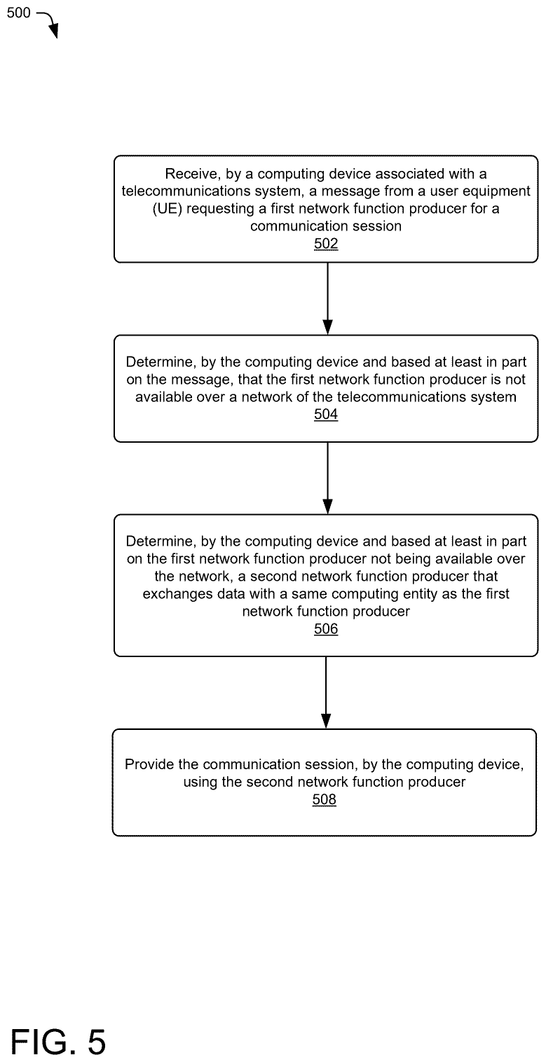

FIG. 5 depicts a flowchart of an example process 500 for providing a communication session using an example NF producer. Some or all of the process 500 may be performed by one or more components in FIGS. 1-4, as described herein. For example, some or all of process 500 may be performed by the access management system 108 of FIG. 1.

At operation 502, the process may include receiving, by a computing device associated with a telecommunications system, a message from a user equipment (UE) requesting a first network function producer for a communication session. In some examples, the operation 502 may include the access management system 108 receiving message data from the UE 102 indicating a first NF producer for providing the communication session (e.g., a call with another UE, access to a service or application, or the like). The access management system 108 can, for example, receive a message (e.g., the message 106) from the UE 102 requesting to establish a voice, video, and/or text communication session that includes an NF producer identifier, IP address, or the like in a portion of the message.

In some examples, the message from the UE can represent a request to attach to a base station or other entity (e.g., an attach request), an identification request associated with an MME (or the like), an identity request, an identity response, a ciphered options request, downlink data, or the like. In various examples, the message from the UE can represent a create session request associated with a gateway of the telecommunications system, uplink data, or a bearer request, among others.

At operation 504, the process may include determining, by the computing device and based at least in part on the message, that the first network function producer is not available over a network of the telecommunications system. For instance, the analysis component 112 can access information associated with the first NF producer and analyze the information to determine a registration status of the first NF producer. In various examples, the analysis component 112 can access cached profile data from the cache 310 using an identifier of the first NF producer and determine that the first NF producer is deregistered from a core network based on the deregistered status.

In some examples, the cache 310 can receive profile data associated with the first NF producer at a first time, and access the profile data at a second time after the first time responsive to receiving the first message form the UE 102. In some examples, the analysis component 112 can determine that the first NF producer 302 is not available over the core network(s) 110 of the telecommunications system 104 based at least in part on an absence of profile data in the cache 310 for the first NF producer 302.

At operation 506, the process may include determining, by the computing device and based at least in part on the first network function producer not being available over the network, a second network function producer is configured to exchange data with a same computing entity as the first network function producer. In some examples, the operation 506 may include the access management system 108 determining that a second NF producer 304 shares, is synchronized with, or is otherwise associated with a same computing entity (e.g., the computing entit (ies) 312) with the first NF producer 302. For example, the analysis component 112 can compare respective profile data of two or more NF producers to identify one or more similarities among characteristics of the NF producers. In examples when multiple NF producers are related to an unavailable NF producer, the analysis component 112 can determine a score to represent a level of similarity of each of the multiple NF producers, and determine a final NF producer to use based on the respective scores (e.g., the highest score can be assigned to the UE 102).

In some examples, the operation 506 may include the access management system 108 sending a request for data to the storage device 116, and using the data to determine availability of an NF producer. In some examples, the data can include profile data and/or a list of available NF producers. The data provided by the storage device 116 can be used during operations to determine an NF producer for the communication session for the UE 102.

At operation 508, the process may include providing the communication session, by the computing device, using the second network function producer. In some examples, the operation 508 may include the access management system 108 selecting the second NF producer for the UE 102 to access a core network independent of the UE 102 specifying the first NF producer in the first message.

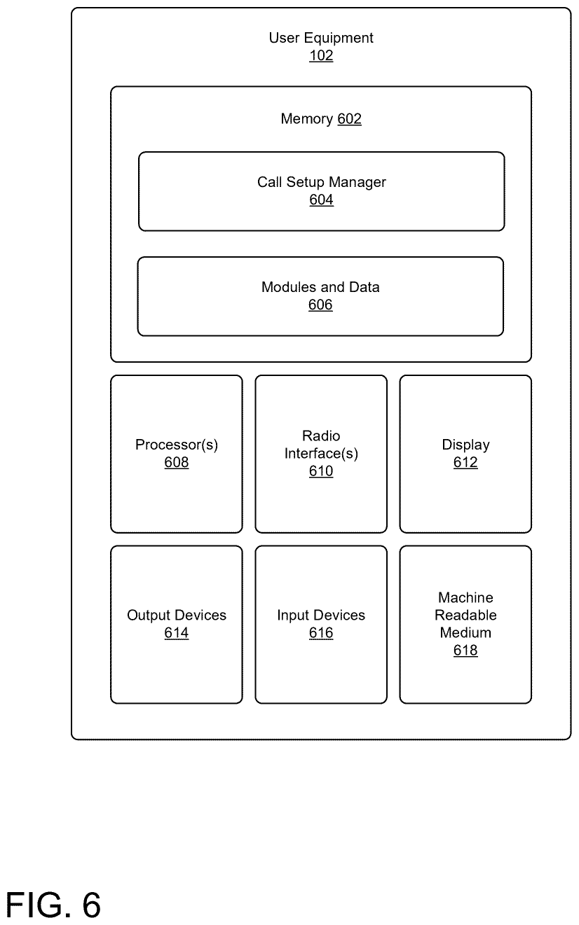

FIG. 6 depicts an example system architecture for the UE 102, in accordance with various examples. As shown, a UE 102 can have memory 602 storing a call setup manager 604, and other modules and data 606. A UE 102 can also comprise processor(s) 608, radio interfaces 610, a display 612, output devices 614, input devices 616, and/or a machine readable medium 618.

In various examples, the memory 602 can include system memory, which may be volatile (such as RAM), non-volatile (such as ROM, flash memory, etc.) or some combination of the two. The memory 602 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 102. Any such non-transitory computer-readable media may be part of the UE 102.

The call setup manager 604 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 606 can be utilized by the UE 102 to perform or enable performing any action taken by the UE 102. The modules and data 606 can include a UE platform, operating system, and applications, and data utilized by the platform, operating system, and applications.

In various examples, the processor(s) 608 can be a central processing unit (CPU), a graphics processing unit (GPU), or both CPU and GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing all computer applications stored in the memory 602, which can be associated with common types of volatile (RAM) and/or nonvolatile (ROM) memory.

The radio interfaces 610 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 610 can be compatible with multiple radio access technologies, such as 5G radio access technologies and 4G/LTE radio access technologies. Accordingly, the radio interfaces 610 can allow the UE 102 to connect to a 5G system and/or a 4G system (or other past or future system) as described herein.

The display 612 can be a liquid crystal display or any other type of display commonly used in UEs. For example, display 612 may be a touch-sensitive display screen, and can then also act as an input device or keypad, such as for providing a soft-key keyboard, navigation buttons, or any other type of interactive input. In some examples, the display 612 can represent a wearable device such as a headset for presenting and/or receiving data associated with a user. The output devices 614 can include any sort of output devices known in the art, such as the display 612, speakers, a vibrating mechanism, and/or a tactile feedback mechanism. Output devices 614 can also include ports for one or more peripheral devices, such as headphones, peripheral speakers, and/or a peripheral display. The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, that embodies any one or more of the methodologies or functions described herein. The instructions can also reside, completely or at least partially, within the memory 602, processor(s) 608, and/or radio interface(s) 610 during execution thereof by the UE 102. The memory 602 and the processor(s) 608 also can constitute machine readable media 618.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, techniques described in FIGS. 5 and 6 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by a computing device associated with a telecommunications system, a message from a user equipment (UE) requesting a first network function producer for a communication session;
determining, by the computing device and based at least in part on the message, that the first network function producer is not available over a network of the telecommunications system;
determining, by the computing device and based at least in part on the first network function producer not being available over the network, a second network function producer that is configured to exchange data with a same computing entity as the first network function producer; and
providing the communication session to the UE, by the computing device, using the second network function producer.

2. The method of claim 1, wherein determining the first network function producer is not available comprises:
identifying the first network function producer in the message received from the UE, and
determining that the first network function producer is deregistered from the network of the telecommunications system, and wherein providing the communication session comprises:
based at least in part on determining that the first network function producer is deregistered from the network of the telecommunications system.

3. The method of claim 1, wherein providing the communication session using the second network function producer is performed independent of sending the UE an indication that the first network function producer is not available.

4. The method of claim 1, further comprising:
retrieving, from a cache of the computing device, first profile data of the first network function producer and second profile data of the second network function producer;
comparing the first profile data and the second profile data, and wherein determining the second network function producer is configured to exchange data with the same computing entity comprises:
determining the second network function producer is related to the first network function producer based at least in part on the comparing.

5. The method of claim 1, further comprising:
receiving a registration status for the first network function producer based at least in part on a change in registration of the first network function producer, and wherein determining the first network function producer is not available comprises:
determining, based at least in part on the registration status, that the first network function producer is not available over the network.

6. The method of claim 1, wherein determining the second network function producer that is configured to exchange the data with the same computing entity as the first network function producer comprises:
determining that the second network function producer and the first network function producer are synchronized to the same computing entity.

7. The method of claim 1, wherein determining the first network function producer is not available comprises:
determining that the first network function producer is not available to provide a user plane and/or a control plane to the UE, and wherein determining the second network function producer is configured to exchange data with the same computing entity comprises:
identifying the second network function producer for providing the user plane and/or the control plane to the UE.

8. The method of claim 1, further comprising:
receiving first profile data of the first network function producer and second profile data of the second network function producer;
wherein the first profile data includes characteristics of the first network function producer, and
the first profile data is received before the message from the UE.

9. A system comprising:
one or more processors; and
memory storing computer-executable instructions that, when executed by the one or more processors, cause the system to perform operations comprising:
receiving, by a computing device associated with a telecommunications system, a message from a user equipment (UE) requesting a first network function producer for a communication session;
determining, by the computing device and based at least in part on the message, that the first network function producer is not available over a network of the telecommunications system;
determining, by the computing device and based at least in part on the first network function producer not being available over the network, a second network function producer that is configured to exchange data with a same computing entity as the first network function producer; and
providing the communication session to the UE, by the computing device, using the second network function producer.

10. The system of claim 9, wherein determining the first network function producer is not available comprises:
identifying the first network function producer in the message received from the UE, and
determining that the first network function producer is deregistered from the network of the telecommunications system, and wherein providing the communication session comprises:
based at least in part on determining that the first network function producer is deregistered from the network of the telecommunications system.

11. The system of claim 9, wherein providing the communication session using the second network function producer is performed independent of sending the UE an indication that the first network function producer is not available.

12. The system of claim 9, the operations further comprising:
retrieving, from a cache of the computing device, first profile data of the first network function producer and second profile data of the second network function producer;
comparing the first profile data and the second profile data, and wherein determining the second network function producer is configured to exchange data with the same computing entity comprises:
determining the second network function producer is related to the first network function producer based at least in part on the comparing.

13. The system of claim 9, the operations further comprising:
receiving a registration status for the first network function producer based at least in part on a change in registration of the first network function producer, and wherein determining the first network function producer is not available comprises:
determining, based at least in part on the registration status, that the first network function producer is not available over the network.

14. The system of claim 9, wherein determining the second network function producer that is configured to exchange the data with the same computing entity as the first network function producer comprises:
determining that the second network function producer and the first network function producer are synchronized to the same computing entity.

15. The system of claim 9, wherein determining the first network function producer is not available comprises:
determining that the first network function producer is not available to provide a user plane and/or a control plane to the UE, and wherein determining the second network function producer is configured to exchange data with the same computing entity comprises:
identifying the second network function producer for providing the user plane and/or the control plane to the UE.

16. The system of claim 9, the operations further comprising:
receiving first profile data of the first network function producer and second profile data of the second network function producer;
wherein the first profile data includes characteristics of the first network function producer, and
the first profile data is received before the message from the UE.

17. One or more non-transitory computer-readable media storing instructions executable by one or more processors, wherein the instructions, when executed, cause the one or more processors to perform operations comprising:
receiving, by a computing device associated with a telecommunications system, a message from a user equipment (UE) requesting a first network function producer for a communication session;
determining, by the computing device and based at least in part on the message, that the first network function producer is not available over a network of the telecommunications system;
determining, by the computing device and based at least in part on the first network function producer not being available over the network, a second network function producer that is configured to exchange data with a same computing entity as the first network function producer; and
providing the communication session to the UE, by the computing device, using the second network function producer.

18. The one or more non-transitory computer-readable media of claim 17, wherein determining the first network function producer is not available comprises:
identifying the first network function producer in the message received from the UE, and
determining that the first network function producer is deregistered from the network of the telecommunications system, and wherein providing the communication session comprises:
providing the communication session using the second network function producer based at least in part on determining that the first network function producer is deregistered from the network of the telecommunications system.

19. The one or more non-transitory computer-readable media of claim 17, the operations further comprising:
retrieving, from a cache of the computing device, first profile data of the first network function producer and second profile data of the second network function producer;
comparing the first profile data and the second profile data, and wherein determining the second network function producer is configured to exchange data with the same computing entity comprises:
determining the second network function producer is related to the first network function producer based at least in part on the comparing.

20. The one or more non-transitory computer-readable media of claim 17, the operations further comprising:
receiving a registration status for the first network function producer based at least in part on a change in registration of the first network function producer, and wherein determining the first network function producer is not available comprises:
determining, based at least in part on the registration status, that the first network function producer is not available over the network.
